(19) United States
(12) Patent Application Publication
(10) Pub. No.: US 2013/0034680 A1
(43) Pub. Date: Feb. 7, 2013

(54) FILAMENTARY SEAMING ELEMENT FOR AN INDUSTRIAL FABRIC AND INDUSTRIAL FABRIC SEAMED USING THE ELEMENT

(71) Applicant: Allan Manninen, Ontario (CA)

(72) Inventor: Allan Manninen, Ontario (CA)

(73) Assignee: ASTENJOHNSON, INC., Charleston, SC (US)

(21) Appl. No.: 13/641,528

(22) PCT Filed: Apr. 15, 2011
(86) PCT No.: PCT/CA11/00443

§ 371 Date: Oct. 16, 2012

(30) Foreign Application Priority Data
Apr. 16, 2010 (CA) 2700767

(51) Int. Cl. D06H 5/00; B23P 11/00; A43C 1/04; B32B 3/06; B32B 37/26

(52) U.S. Cl. 428/61; 28/141; 156/60; 24/714.6; 24/714.9; 29/428

(57) ABSTRACT

A seaming element for joining opposed ends of woven or nonwoven industrial textiles, textiles including seaming elements, and methods of making a seam area for textiles. The seaming element comprises a continuous filamentary structure, configured as first and second layers of aligned looped segments, each segment of one layer being connected to adjacent segments of the other layer by a connecting portion. The seaming elements can be bonded directly to the fabric edges, or inserted into the fabric so that free ends of the looped segments engage and are secured by selected MD yarns or components. Connecting portions of complementary elements when interdigitated together define a continuous channel to receive a pintle. The seaming element is readily and securely installed in the textiles, and overcomes problems of alignment of fabric ends for securing a seam, while minimizing any disruption in fabric properties adjacent the seam area.

### FIELD OF THE INVENTION

The present invention concerns a seaming element for use in industrial fabrics, in particular filtration fabrics such as papermaking fabrics, and fabrics seamed using the element. The invention has particular relevance to a seaming element which may be used to join the opposing ends of both woven and nonwoven industrial fabrics, either by bonding the element directly to the fabric edges, or by insertion into the fabric behind selected MD yarns where a fold line is provided.

### BACKGROUND OF THE INVENTION

Industrial fabrics are textile products manufactured for non-aesthetic purposes, generally for use in an industrial process, where function is the primary criterion, such as filtration and conveyance. These fabrics may be woven or nonwoven, using sets of yarns, i.e. either interlaced about one another in a regular manner, or laid as independent arrays which are intermingled or otherwise bonded together; or the fabrics can comprise sheets or strips of a continuous nonwoven material such as film or a bonded fibrous material. The present invention is applicable to all of such types of fabric, but it is particularly relevant to those industrial fabrics which include either: a) at least a machine direction (MD), or longitudinal direction fabric component system, preferably including yarns, or b) continuous nonwoven materials such as sheets or strips of film.

Such industrial fabrics are used for many filtration and conveyance applications, and in particular for use in papermaking and similar machines. In the discussion below, some of the features of the invention are described with particular reference to papermaking fabrics, but it will be appreciated that the invention is not limited to such fabrics, and is applicable to a wide range of filtration and conveyance operations.

Papermaking fabrics conventionally comprise three general categories, i.e. forming fabrics, press fabrics and dryer fabrics, based on the location within the papermaking machine of their intended end use. The different operating environment for these three categories results in the differences in the required physical properties for the fabrics in each group, and in particular for any required seaming of the fabrics. However, each of the industrial textiles used in the papermaking process, i.e. the forming, press and dryer fabrics, all take the form of endless loops on the papermaking machine, and function as conveying and support belts.

During the papermaking process, a dilute aqueous slurry typically consisting of about 99% water and 1% cellulosic papermaking fibers, is directed at high speed and with precision onto a moving forming fabric in the sheet forming section of a papermaking machine. A large amount of the water is drained through the fabric, leaving behind a weakly cohesive mat or web of fibers on the surface of the forming fabric. This newly formed web proceeds from the forming section to a press section, which includes a series of press nips. The fibrous web passes through the press nips while supported by at least one press fabric, or sandwiched between two such fabrics. In the press nips, the web is subjected to compressive forces which squeeze water from the mat into the press fabrics, allowing the cellulosic fibers to adhere to one another, thus forming a somewhat cohesive, embryonic paper sheet. This sheet is then transferred to the dryer section which conventionally includes a series of internally steam heated rotating dryer cylinders; the sheet is directed in a serpentine path sequentially around each in the series of dryer cylinders by one or more dryer fabrics which hold the paper sheet closely against the surfaces of the cylinders so as to remove the remainder of the water by evaporative means.

Forming fabrics are typically finely woven structures comprised of small diameter polymeric monofilaments interwoven as the warp and weft yarns in the loom. These fabrics, which may be of various single or multi-layer constructions, present a very fine paper side surface to uniformly support the papermaking fibers in the stock slurry, but are also open to allow drainage of fluid and thus form a somewhat cohesive mat of fibers. Forming fabrics are conventionally rendered endless by means of a woven seam whereby the warp and well yarns at the fabric edges are unwoven and then rewoven according to a desired pattern so as to securely join the opposing fabric edges in a manner that minimizes any discontinuity at the seam region. These seams are time consuming and difficult to produce, and currently require the skills of trained personnel and expensive equipment to construct. Forming fabrics are well known in the papermaking arts and have been recently described, for example in U.S. Pat. No. 5,826,627 (Seabrook et al.), U.S. Pat. No. 7,108.020 (Stone) and U.S. Pat. No. 7,426,944 (Danby et al.).

Dryer fabrics are also typically woven constructions somewhat similar to forming fabrics, but the yarn sizes employed, and their arrangement, are often quite different. Dryer fabrics are used mainly to support and convey the somewhat more robust sheet from the press through the dryer section of the papermaking machine. They are therefore often much more coarsely woven than forming fabrics and typically provide a smooth surface and permeable construction upon which the sheet is conveyed. Many examples of dryer fabrics are known in the art, of which U.S. Pat. No. 4,290,209 (Buchanan et al.) and U.S. Pat. No. 5,092,373 (Lee) are representative examples. These fabrics are typically rendered endless by means of a coil type seam, comprising a pair of complementary coil shaped components which are attached to the opposed fabric ends and are shaped to accept a pin or pintle. It is also known to form these fabrics from polymeric films which have been selectively contoured and slit in the manner described in PCT/CA2010/001956. Through-air dryer (TAD) fabrics share similarities with both forming and dryer fabrics, in that they are typically finely woven structures used to both convey and to shape a low basis weight web of fibers intended for tissue, towel and similar absorbent paper products in an air driven drying process. TAD fabrics must also be rendered endless by means of a seam, which is typically either woven as in forming fabrics, or is of a coil type similar to that used in dryer fabrics. Regardless of their construction, whether woven or nonwoven, it is necessary to provide a means to render these fabrics endless following their installation on the machine for which they are intended.

Press fabrics are subjected to extremely high pressures when supporting and carrying the paper web through the press nips of the press section. Such fabrics are therefore required to present a smooth and uniform surface to the paper product, to avoid marking the sheet they are conveying. At the same time, press fabrics must be capable of accepting the large quantities of water that are extracted from the wet paper web in the press nips. In order to do this, there must be space, referred to as “void volume”, within the fabric to carry the water, and the fabric must have sufficient permeability to water during its operational life. Press fabrics must also be constructed so as to prevent the water they are carrying from returning and rewetting the paper web upon exit from the press nips.

Press fabrics are currently produced in a variety of designs and styles so as to meet papermaking requirements. They will generally be comprised of either a woven base fabric (which may be flat or endless woven), or they may be assembled from one or more arrays of yarns, to which a batt of very fine nonwoven fibrous material is attached, such as by needling. The base fabrics may be comprised of synthetic polymeric monofilaments, multifilaments or plied multifilaments, and may be of single or multilayer construction, or they may be formed of several such layers laminated together. One particular type of these base fabrics is a so-called spirally wound, or multiaxial, construction such as is described in U.S. Pat. No. 5,360,656 (Rexfelt et al.) and U.S. Pat. No. 5,268,076 (Best et al.).

The base fabric for a multiaxial fabric is assembled by spirally winding successive turns of a relatively narrow fabric strip which is abutted to and joined in a desired manner to the next adjacent turn; the resulting fabric is endless in the longitudinal, or intended machine direction (MD) of the completed fabric. The fabric strip is generally woven from lengthwise (warp) and crosswise (weft) yarns, however, it is also known to assemble such a strip from nonwoven arrays of lengthwise and crosswise oriented yarns which are held together in such orientation by various binding methods, such as in US 20070254546 (Despault). The spacing between the lengthwise yarns in the fabric strip may be adjusted according to need.

It is also known to construct press fabrics comprising a base having two layers each composed of a spirally wound strip; both layers take the form of an endless loop, one being inside the other. Preferably, the spirally wound strip of one layer will spiral in a direction opposite to that of the strip formed by the other. In such a two-layer construction, the lengthwise yarns of the fabric strip in each layer will be oriented at differing small angles to one another and to the intended MD of the base fabric. Similarly, the crosswise yarns in one layer will be oriented at a different angle from those in the adjacent layer, and both will form angles that differ from the intended cross-machine direction (CD) of the base fabric. Thus, neither the lengthwise yarns nor the crosswise yarns of the fabric strips in either layer align one with the other, nor with the CD and MD of the finished fabric, which has the significant disadvantage of restricting the feasible methods of seaming such fabrics.

For this reason, until recently, such multiaxial fabrics had been produced only in endless form (i.e. without a seam), so their use was restricted to press sections having cantilevered press rolls and other components which permit an endless fabric to be installed from the side of the press section. However, their relative ease of manufacture, as well as other benefits of their construction, have created a growing need for a multiaxial fabric which could be seamed into endless form during installation on papermaking machines lacking cantilevered components.

It is known to form such seams in a variety of ways, but the predominant method has been to manipulate the MD oriented yarns of the fabric so as to form loops on each opposing fabric end at the two fold areas; e.g. as disclosed in U.S. Pat. No. 7,207,355 (Lee). However, a problem common to all such fabrics whose seaming loops are formed using the MD yarns relates to the alignment of the loops at the opposed fabric edges. Because the vast majority of these multiaxial fabrics must be joined by hand on the machine, it is critical that the fabric ends be easily joined, usually by manual insertion of a pintle, or pin, across the full width of the fabric through the seaming loops. As papermaking and similar machines have become larger, the width of these fabrics has increased correspondingly and may be as much as 10 meters or more in machines currently in use. Where a portion of the CD elements such as yarns are removed adjacent each fold area of the fabric in order to free the MD components to form the required loops, it is difficult to ensure that the loops are precisely aligned at the fold areas to facilitate the pintle insertion during fabric installation.

It is also known, for example from U.S. Pat. No. 5,939,176, U.S. Pat. No. 6,117,274, and U.S. Pat. No. 6,776,878 (all to Yook) to flatten a spirally wound base fabric upon itself to provide two plies, and to remove selected CD yarns to expose MD yarns to form seaming loops. However, where the CD yarns are canted at an angle to the CD, it is necessary to pick them in a stepwise fashion across the fabric width to expose both sides of the fold.

U.S. Pat. No. 6,265,048 (Rydin et al.) discloses the use of a special loop forming device to form loops in a laminated multiaxial fabric with yarn systems inclined relative to the intended machine direction (MD) of the fabric.

It is further known from U.S. Pat. No. 5,916,421 (Yook) to provide an on-machine seam for multiaxial press fabrics by positioning a seaming element at the CD widthwise folds of the flattened multiaxial base fabric where some of the CD yarns have been removed to expose the MD yarns. The patent discloses a seaming element formed as a length of fabric produced by weaving weft yarns continuously back and forth across the loom and about a pin to form the seaming loops, according to techniques described in U.S. Pat. No. 3,815,645 (Cordorniu). The seaming element is installed between the layers so that the loops extend outwards between the MD yarns, and the element is then stitched in place. However, as noted in the patent, the seaming element causes a triple ply region to exist at the seam, so that a fabric with such seam would not be suitable for use in situations where marking may be a problem.

It is also known from U.S. Pat. No. 4,896,702 (Crook) to flatten an endless woven papermaking fabric to form a base fabric having sidewalls at the opposed folded edges, and to insert a helical coil type seaming element between the opposing sidewall portions so that the coils extend through spaces between adjacent MD yarns and supportably engage those yarns. Similarly, U.S. Pat. No. 5,031,283 (Aldrich) discloses a helical coil formed from a plurality of twisted plies of multifilament yarn which can be inserted into the fabric in the same manner as is described in U.S. Pat. No. 4,896,702 (Crook).

Pin and coil seams are well known for industrial fabrics for filtration and conveyance. Coils for such seams conventionally comprise spiral elements which can be interdigitated with seaming loops and secured by additional yarns, so that a coil is provided at each end of a fabric to be joined, and the pair of coils can be joined to each other by suitable means, such as a pintle. However, none of the known coils is suitable for attachment to the opposing exterior surfaces of the fabrics for which they are intended.

It is also known from U.S. Pat. No. 4,862,926 (Barrette et al.) to flatten the surfaces of the coils at their ends, to allow for insertion of a larger pintle without creating a caliper discontinuity at the seam region.

Various other methods have been disclosed to assist in providing a seaming means for a multiaxial fabric which attempt to both minimize any fabric discontinuity and improve the overall seamability of the fabric when it is installed on the machine for which it is intended. The solution proposed by Lee in U.S. Pat. No. 7,207,355 has been effective; however, none has been wholly satisfactory in addressing the problems of seam uniformity and pintle insertion resulting from uneven seam loop length.

None of the conventional methods discussed above for seaming woven fabrics is suitable for seaming nonwoven fabrics which are either constructed from a planar film, or comprise yarns which cannot be used to form loops.

Recently it has been found that various advantages, including simplicity of construction, economic benefits, and improved physical properties, can be obtained in industrial applications by the use of planar films, preferably constructed of polymeric materials. In particular, as disclosed in PCT/CA2010/001956, incorporated herein by reference, it has been found that an industrial fabric having properties similar to those of a woven fabric can be formed from a polymeric film, which is selectively provided with contouring similar to that resulting from various weave designs for woven fabrics, by a combination of an embossing or similar process, generally through heat and pressure, to raise portions or deformations of the film above its general plane, and slits to create apertures in the deformations, for the passage of fluid, e.g. liquid drainage or air passage through the fabric. Still further advantages can be obtained by providing multiple layers of such polymeric film, wherein the slit areas between the deformations allow for the passage of fluid, while the deformations maintain an interior space or void between the two layers.

For fabrics constructed in this or by other methods from polymeric films, seams can be provided by various known methods. However, it has been found that the seaming element of the present invention is particularly advantageous for joining the opposing ends of a nonwoven fabric that is constructed from a selectively slit and embossed film in the manner described in PCT/CA2010/001956.

It has now been found that a seaming element can be constructed as a continuous filamentary structure, which is deformedly set in a configuration to form a plurality of looped segments aligned as first and second layers, and connected to one another by a connecting portion. This allows the seaming element to be secured to seamable ends or edges of an industrial fabric of woven or nonwoven construction, either by insertion in the interior of a fold in the fabric such that looped portions of the element protrude through the fabric to provide seaming loops, or by being bonded to the outer surfaces of the fabric.

### SUMMARY OF THE INVENTION

The invention provides advantageous seaming elements, fabrics including the seaming elements, and methods of making the seaming elements and the fabrics, the seaming element having a structure which is deformedly set in a configuration to form two layers of looped segments, connected by connecting portions. The continuous filamentary structure of the seaming element is shaped and dimensioned according to the mesh and yarn size of the fabric into which it is to be placed so as to minimize any disruption in fabric properties adjacent the seam area, and permit the securing of the element to the fabric by the selected method. The connecting portions and adjacent portions of the looped segments provide a pintle receiving channel, while the free ends and adjacent portions of the looped segments engage with the selected part of the fabric body adjacent the edge, to retain the seaming element in the desired position. When the opposed ends of the fabric are each equipped with a filamentary seaming element configured in this manner, they may be joined, as discussed further below, by bringing the connecting portions together to form a continuous channel through which a joining pintle may be passed.

The seaming elements of the present invention are particularly advantageous for on-machine seamable industrial fabrics which include a base fabric structure into which a pre-fabricated seaming element is installed at the lateral (CD) edges to enable the fabric ends to be joined. The industrial fabric may consist of a multiaxial base fabric structure comprised of a plurality of spirally wound turns of a narrow woven fabric which have been joined together along their longitudinal edges, or the base structure may consist of an MD oriented array of yarns which have been joined together by a chosen bonding means to form a cohesive structure (e.g. as described in U.S. Pat. No. 6,491,794). The base fabric structure may also be a woven structure which has been folded at its CD edges to provide two separate plies at that location, or it may be a wholly nonwoven structure such as a film or other nonwoven fibrous or continuous material which has been laid flat and folded to form two separate plies and fold edges.

The seaming elements of the present invention are also useful for seaming industrial textiles which are wholly woven, such as papermaker's dryer and forming fabrics, as well as textiles intended for various other continuous processes, such as nonwovens production, filtration and conveyance.

The invention therefore seeks to provide a seaming element for seaming edges of an industrial textile, the seaming element comprising a continuous filamentary structure deformedly set in an elongated configuration, the continuous filamentary structure comprising a plurality of looped segments alternated with connecting portions, wherein

(i) each connecting portion is spaced apart from each adjacent connecting portion and is configured to separate adjacent ones of the looped segments alternately into a first layer of looped segments and a second layer of looped segments;

(ii) each looped segment comprises a looped outer free end portion and two leg portions, each leg portion extending in the respective one of the first layer and the second layer from the outer free end portion to an adjacent one of the connecting portions;

(iii) the looped segments of the first layer are coplanar and are aligned with each other at their respective outer free end portions, and the looped segments of the second layer are coplanar and are aligned with each other at their respective outer free end portions; and

(iv) the outer free end portions of the seaming element are constructed and arranged to be securable to a selected first edge of the industrial textile, such that the connecting portions of the seaming element are engageable in securable alignment with the corresponding connecting portions of a complementary seaming element correspondingly provided at an opposing second edge of the industrial textile, the connecting portions together defining a continuous longitudinal channel.

Optionally, each of the leg portions in the first layer has a first leg length, and each of the leg portions in the second layer has a second leg length, and the second leg length is different from the first leg length.

In one aspect of this broad embodiment, the industrial textile comprises a textile body, a first folded end region having a first fold line, a second folded end region having a second fold line, wherein portions of the industrial textile adjacent to the first and second fold lines respectively define first and second internal spaces, and each of the first and second fold lines comprises a plurality of spaced apart apertures, and the seaming element is constructed and arranged to be insertable into and securable within the first internal space, such that

(a) the connecting portions and at least part of the leg portions of each of the first looped segments and each of the second looped segments protrude through the apertures along the first fold line;

(b) the textile body between the apertures along the first fold line engages with the aligned outer free ends of the first and second looped segments; and

(c) the connecting portions of the seaming element are engageable in securable alignment with the corresponding connecting portions of a complementary seaming element correspondingly provided at the second folded end region, the connecting portions together defining a continuous longitudinal channel.

In a further broad embodiment, the invention seeks to provide a seaming element for seaming an industrial textile, the industrial textile comprising a textile body, a first folded end region having a first fold line, a second folded end region having a second fold line, wherein portions of the industrial textile adjacent to the first and second fold lines respectively define first and second internal spaces, and each of the first and second fold lines comprises a plurality of spaced apart apertures, the seaming element being a continuous filamentary structure deformedly set in an elongated configuration and comprising a plurality of looped segments alternated with connecting portions, wherein

(i) each connecting portion is spaced apart from each adjacent connecting portion and is configured to separate adjacent ones of the looped segments alternately into a first layer of looped segments and a second layer of looped segments;

(ii) each looped segment comprises a looped outer free end portion and two leg portions, each leg portion extending in the respective one of the first layer and the second layer from the outer free end portion to an adjacent one of the connecting portions;

(iii) the looped segments of the first layer are coplanar and are aligned with each other at their respective outer free end portions, and the looped segments of the second layer are coplanar and are aligned with each other at their respective outer free end portions; and

(iv) the seaming element is constructed and arranged to be insertable into and securable within the first internal space, such that

(a) the connecting portions and at least part of the leg portions of each of the first looped segments and each of the second looped segments protrude through the apertures along the first fold line;

(b) the textile body between the apertures along the first fold line engages with the aligned outer free ends of the first and second looped segments; and

(c) the connecting portions of the seaming element are engageable in securable alignment with the corresponding connecting portions of a complementary seaming element correspondingly provided at the second folded end region, the connecting portions together defining a continuous longitudinal channel.

In the seaming elements of the invention, preferably at least some of the looped segments further comprise at least one securing means constructed and arranged to secure the seaming element to a selected one of the edges of the industrial textile.

In one aspect, the looped segments of the first and second layers comprise opposing inner surfaces, and the seaming element is securable to the industrial textile along at least some of the inner surfaces of at least one of the first and second layers.

In another aspect, the leg portions of the looped segments of the first and second layers each comprise opposing inner surfaces and further comprise corresponding outer surfaces in a plane of the respective layer, and the seaming element is securable to the industrial textile along at least some of the outer surfaces of the looped segments of at least one of the first and second layers.

Preferably, the securing means comprises a material sensitive to radiation selected from UV radiation, laser radiation, visible and infrared light, microwave radiation, ultrasound and heat and provided to at least some of the looped segments of at least one of the first and second layers.

Optionally, the continuous filamentary structure is constructed of a polymer material including a substantially uniformly dispersed laser energy absorbing material, in which case preferably the polymer material is selected from a polyester and a polyamide. More preferably, the polymer material is a thermoplastic polyester or a thermoplastic polyamide.

Preferably, the continuous filamentary structure is constructed of a material selected from an extruded polymer and metal wire.

Optionally, the material sensitive to radiation is a laser energy absorbing material and comprises a coating layer. Alternatively, the continuous filamentary structure comprises an extruded polymer and the material sensitive to radiation is a laser energy absorbing material comprising a co-extruded outer layer.

As a further option, the material sensitive to radiation is a laser energy absorbing material comprising a film layer.

Preferably, the material sensitive to radiation is selected from carbon black and a radiant energy absorbing dye.

In a further aspect, optionally the seaming element further includes an external securing means secured to at least some of the looped segments of at least one of the first and second layers at their inner surfaces; alternatively, the seaming element further includes an external securing means secured to at least some of the looped segments of at least one of the first and second layers at their outer surfaces.

Preferably, the external securing means comprises at least one bondable strip secured to the looped segments of the first layer; alternatively, the external securing means further comprises at least one bondable strip secured to the looped segments of the second layer, or of both layers.

Preferably, the bondable strip comprises a thermoplastic polymer material.

As a further option, the external securing means comprises at least one pair of bondable yarns interlockingly interwoven with each other and with selected ones of the looped segments of the first layer. Alternatively, the external securing means comprises at least one pair of bondable yarns interlockingly interwoven with each other and with selected ones of the looped segments of the second layer, or of both layers.

Where the industrial textile comprises yarns, and the seaming element is for insertion within a folded region of the textile body, preferably the textile body between the apertures along each fold line comprises selected folded ones of the yarns.

In a further broad embodiment, the invention seeks to provide an industrial textile comprising a pair of seaming elements of the invention.

In one aspect of this embodiment, the seaming elements are bonded to the industrial textile by a bonding means. Preferably, the bonding means is selected from at least one of an adhesive bond, an epoxy bond, a chemically reactive bond, an ultrasonic weld, a laser weld and a stitched bond.

In this embodiment, the two seaming elements can have the same configuration as each other, or have a different configuration from each other.

In one aspect, the industrial textile is a papermakers fabric, and each seaming element is provided either in a machine direction of the fabric, or in a cross-machine direction of the fabric.

In another aspect, the industrial textile is an industrial conveying fabric or an industrial filtration fabric.

Where the industrial textile is a papermaking fabric, it can be a forming fabric, press fabric, dryer fabric or a through-air dryer fabric.

In a further broad embodiment, the invention seeks to provide a method of preparing a seam area for an industrial textile, the industrial textile comprising first and second seamable edges, the method comprising

(a) providing a first seaming element and a complementary second seaming element, each according to the invention;

(b) selectively providing securing means to selected ones of the first seaming element, the second seaming element, and the industrial textile adjacent the first and second seamable edges; and

(c) securing the first seaming element to the first seamable edge and securing the second seaming element to the second seamable edge.

In one aspect, the providing in step (a) comprises constructing at least one of the first seaming element and the second seaming element to include a material sensitive to radiation selected from UV radiation, laser radiation, visible and infrared light, microwave radiation, ultrasound and heat, and preferably as discussed in more detail above in relation to the seaming elements of the invention.

In another aspect, the selectively providing in step (b) comprises providing a securing means secured to at least some of the looped segments of at least one of the first and second layers at inner surfaces of the looped segments.

Alternatively, the selectively providing in step (b) comprises providing a securing means secured to at least some of the looped segments of at least one of the first and second layers at outer surfaces of the looped segments.

Optionally, the selectively providing in step (b) comprises providing securing means comprising at least one bondable strip. Preferably, the bondable strip comprises a thermoplastic polymer material.

Optionally, the selectively providing in step (b) comprises providing securing means comprising at least one pair of bondable yarns interlockingly interwoven with each other and with selected ones of the looped segments of the first layer of at least one of the first seaming element and the second seaming element. Alternatively, the selectively providing in step (b) comprises providing securing means comprising at least one pair of bondable yarns interlockingly interwoven with each other and with selected ones of the looped segments of the second layer of at least one of the first seaming element and the second seaming element.

In a further broad embodiment, the invention seeks to provide a method of preparing a seam area for an industrial textile, the method comprising

(a) providing a first folded end region having a first fold line to comprise a first seaming location and a second folded end region having a second fold line to comprise a second seaming location, the first and second fold lines defining first and second internal spaces between textile body portions adjacent to the first and second fold lines respectively;

(b) providing along each of the first and second fold lines a plurality of spaced apart apertures between the textile body portions;

(c) providing a first seaming element and a second seaming element, each according to the invention;

(d) inserting the first seaming element within the first internal space, and inserting the connecting portions and at least part of the leg portions of each of the first looped segments and each of the second looped segments through the apertures to form a plurality of first protrusions from the first fold line such that the outer free ends of each of the first and second looped segments are engaged with the textile body portions along the first fold line;

(e) inserting the second seaming element within the second internal space, and inserting the connecting portions and at least part of the leg portions of each of the first looped segments and each of the second looped segments through the apertures to form a plurality of second protrusions from the second fold line such that the outer free ends of each of the first and second looped segments is engaged with the textile body portions along the second fold line; and

(f) securing each of the first and second elements within the respective first and second internal spaces.

In one aspect of this embodiment, the industrial textile comprises yarns, and step (b) comprises removal of selected yarns substantially parallel to and at the fold line.

Optionally, the method further comprises after step (d) the step of (d.1) inserting a temporary securing means through the protrusions of each seaming element; and after step (f), the step of (g) removing the temporary securing means.

Optionally, the securing in step (f) comprises securing each seaming element to retain the looped segments in a protruding position, for example by stitching.

Optionally, the securing in step (f) comprises inserting a retaining element adjacent the location of engagement of the outer free ends of each seam element with the fabric body portions. Preferably, such retaining element is selected from a filling yarn element, a pin and a pintle, and such filling yarn element is selected from a monofilament yarn, a cabled monofilament yarn, a multifilament yarn, a spun yarn and a braided material, and optionally can be provided with an adhesive coating.

As a further option, the securing in step (f) comprises inserting a melt-fusible retaining yarn element, preferably selected from a monofilament yarn, a cabled monofilament yarn, a multifilament yarn, a spun yarn and a braided material. More preferably, the securing in step (f) comprises inserting a melt-fusible retaining yarn element which is sensitive to radiation selected from UV radiation, laser radiation, visible and infrared light, microwave radiation, ultrasound and heat.

As a further option, the retaining element is secured to the outer free ends of the looped segments of the seam element and to the yarns in the fabric body by adhesive bonding.

In one aspect, the industrial textile comprises at least two sets of yarn elements cohesively secured in a pattern selected from woven, non-woven and a combination thereof, and optionally at least one set of the at least two sets of yarn elements comprises two layers of yarn elements.

In this embodiment also, step (c) can comprises providing first and second seaming elements having the same configuration as each other, or having a different configuration from each other.

### BRIEF DESCRIPTION OF THE DRAWINGS

The invention will be described with reference to the drawings, in which:

FIG. 1 is a perspective view of a seaming element in an embodiment of the invention;

FIG. 2 is an end view of the seaming element of FIG. 1;

FIG. 3 is top view of the seaming element of FIG. 1;

FIG. 4 is a top perspective partial view of a seaming element and fabric in an embodiment of the invention;

FIG. 5 is a top view of the seaming element and fabric of FIG. 4;

FIG. 6 is a side cross-sectional view of the seaming element and fabric of FIG. 5;

FIG. 7 is a top perspective partial view of a pair of seaming elements attached to a fabric and connected together in an embodiment of the invention;

FIG. 8 is a side cross-sectional view of the seaming elements and fabric of FIG. 7; and

FIG. 9 is a perspective view of the seam area of an industrial textile, with seaming elements attached to the exterior surfaces of the textile, in an embodiment of the invention.

### DETAILED DESCRIPTION OF THE DRAWINGS

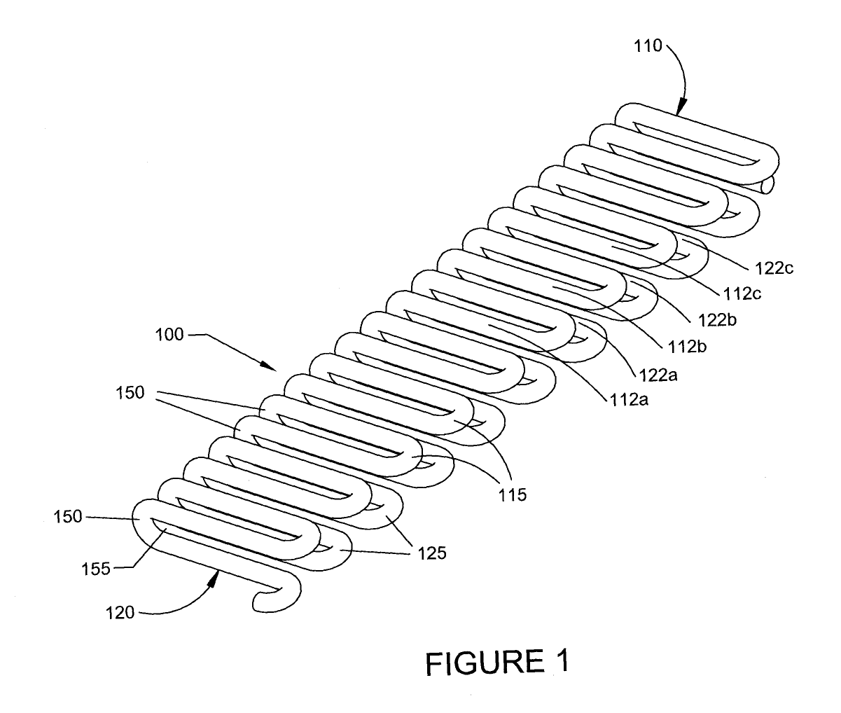

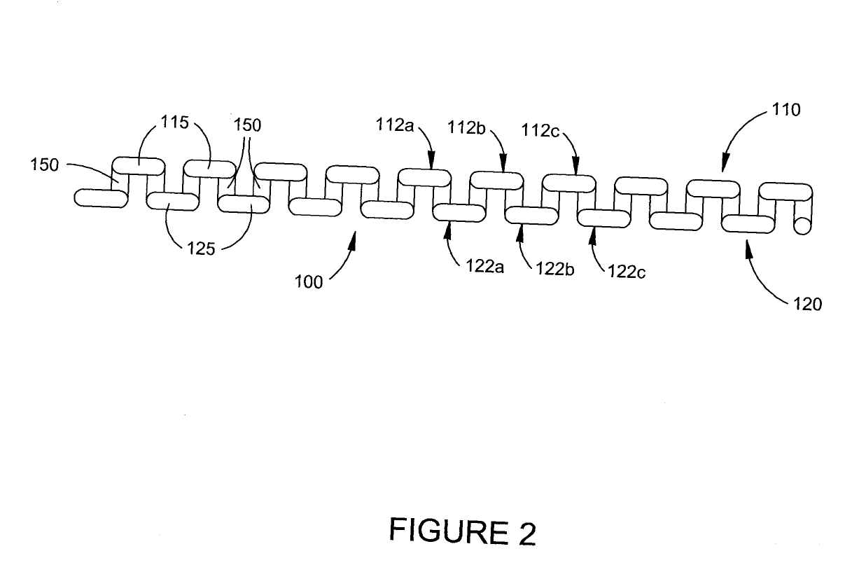

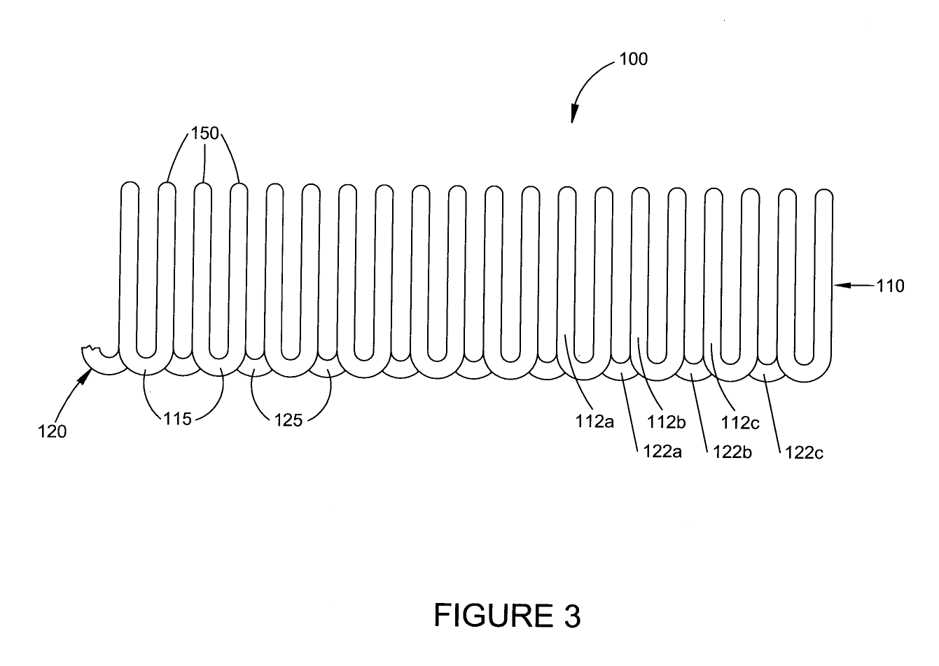

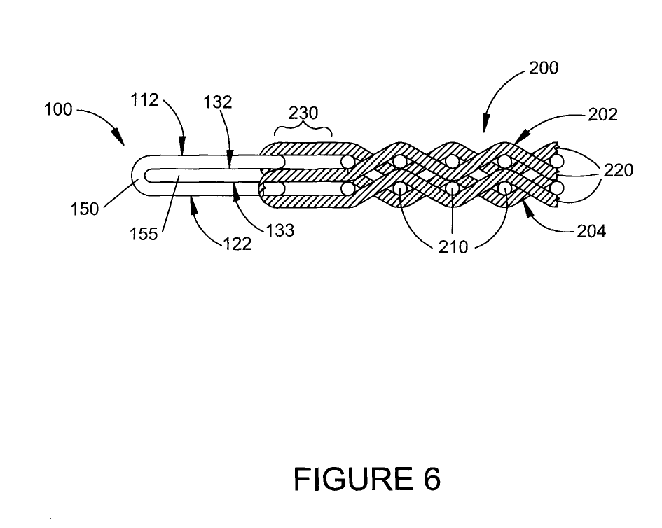

Referring to FIGS. 1 to 3, an embodiment of a seaming element 100 of the invention is shown. As shown in FIG. 1, the seaming element 100 comprises a continuous filamentary structure which is deformedly set in a configuration to form a plurality of looped segments 112, 122 (identified as individual segments in FIG. 1 as 112a, 112b, 112c, 122a, 122b, 122c, and further identified in general in FIG. 6), aligned as a first layer 110 of segments 112 and a second layer 120 of segments 122, each segment 112 being connected to each adjacent segment 122 by a connecting portion 150 to form the continuous filamentary structure of the seaming element 100, the connecting portions 150 being curved outwards from the respective segments 112, 122, so as to define a channel 155 between the concave inner curvature of the connecting portions 150 and the adjacent leg portions of the segments 112, 122. At the opposite end from the connecting portions 150, each of the segments 112 has a looped outer free end 115, and similarly each of the segments 122 has a looped outer free end 125.

As can be seen in each of FIGS. 1 to 3, the segments 112 of the upper layer 110, and their respective outer free ends 115, are offset from the segments 122 of the lower layer 120 and their respective outer free ends 125. The outer free ends 115 of the segments 112 of the upper layer 110 are coplanar and aligned with each other, and the outer free ends 125 of the segments 122 of the lower layer 120 are coplanar and aligned with each other, as viewed across the seaming element 100. In the embodiment shown in FIGS. 1 to 3, the outer free ends 115 are also substantially aligned with the outer free ends 125, as seen across the seaming element 100, but in some embodiments the segments can be configured so that the outer free ends of one layer extended beyond those of the other layer.

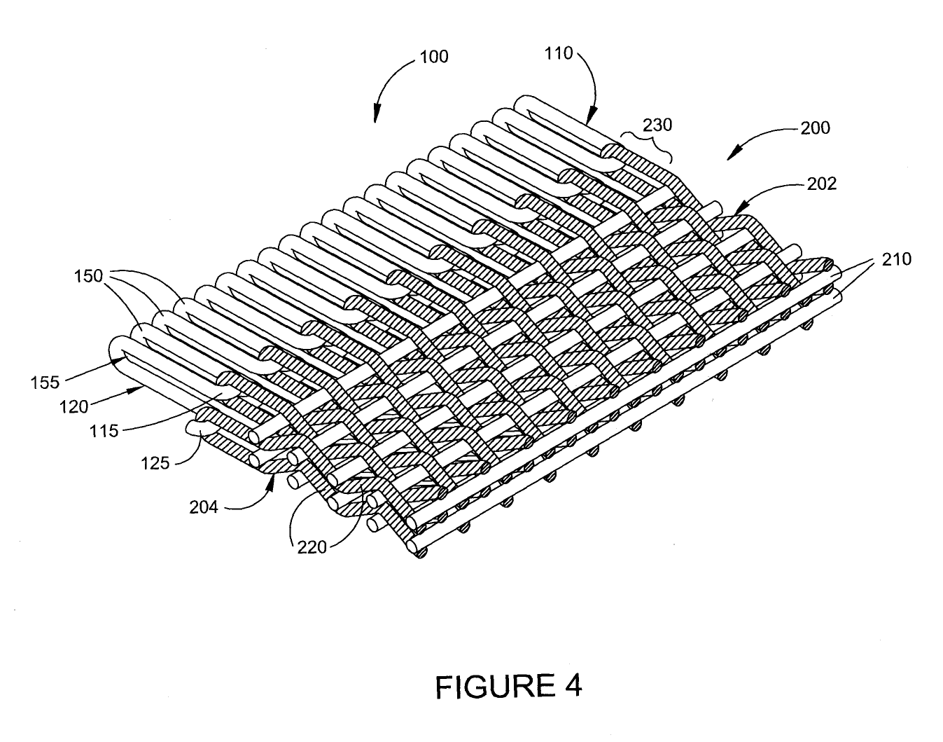

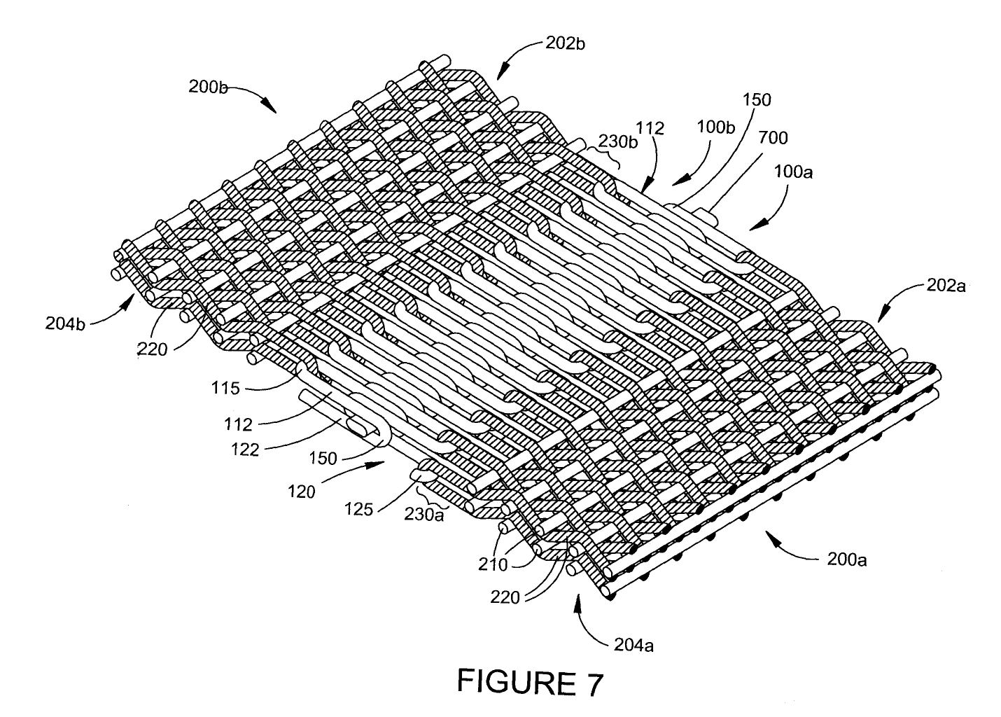

Between the upper layer 110 and the lower layer 120, the connecting portions 150 and the leg portions of the two layers of looped segments 112, 122 define a channel 155. When the seaming element 100 is secured to a seamable end of a fabric, as discussed further below in relation to FIGS. 4 to 9 in different embodiments of the invention, the connecting portions 150 and adjacent leg portions of the segments 112, 122, and channel 155 will extend beyond the edge of the fabric. As discussed below in relation to FIGS. 7 to 9, when a seaming element is secured to each seamable end or edge of a fabric, the protruding portions of each seaming element can be aligned and interdigitated, and a securing means inserted through the combined channel 155.

FIG. 4 shows a seaming element 100 secured in a woven fabric 200 in an embodiment of the invention, in which the seaming element has been inserted within a folded region of a fabric 200 to be seamed. The connecting portions 150 are configured so that when the seaming element 100 is inserted within the folded region, and adjacent to the fold line at area 230, the connecting portions will pass through apertures along the fold line.

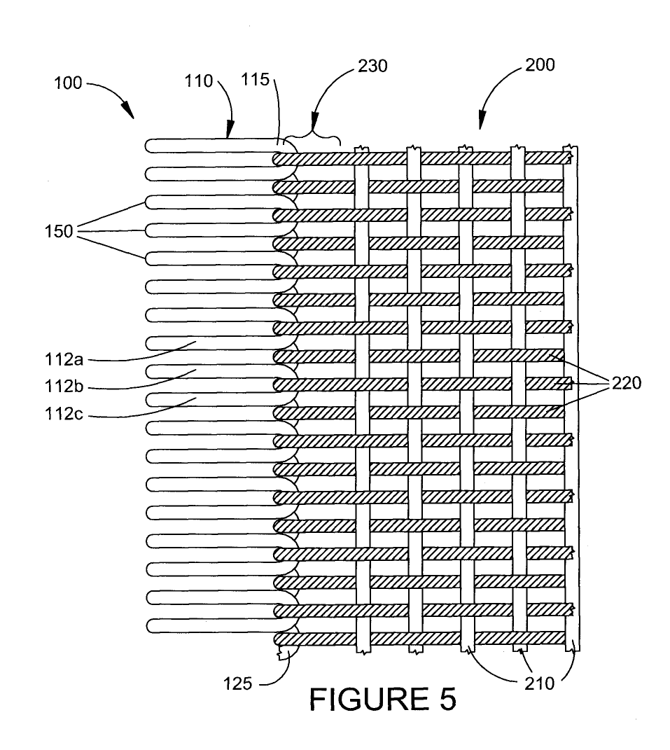

In this example, the apertures result from the removal of one or more cross-machine direction yarns 210 from the woven fabric 200 at the desired fold line, leaving the machine direction yarns 220 as body portions of the fabric along the fold line. As the seaming element is inserted between upper fabric layer 202 and lower fabric layer 204 within the folded region 230 of the fabric, and the connecting portions 150 and adjacent leg portions of the segments 112, 122 pass through the apertures between adjacent MD yarns 220, consecutive ones of the yarns 220 will engage with alternating ones of the segments 112, 122, in the sequence shown in FIGS. 1 to 3 as 112a, 122a, 112b, 122b, 112c, 122c, in each instance at the inner surfaces of the respective outer free ends 115, 125, to retain the seaming element 100 in the required position. This engagement alternating between upper layer segments 112 and lower layer segments 122 can best be seen in FIG. 5, which is a top view of the embodiment of FIG. 4, and showing seaming element 100 installed in fabric 200.

FIG. 6 is a side cross-sectional view of a seaming element 100 installed in a fabric 200 in an embodiment of the invention, such as shown in FIG. 5, further illustrating the channel 155 defined between the connecting portions 150 and the inner surfaces 132, 133 of the leg portions of the looped segments 112, 122, and the engagement of the seaming element 100 within the folded region 230 between the two layers 202, 204 of the fabric 200.

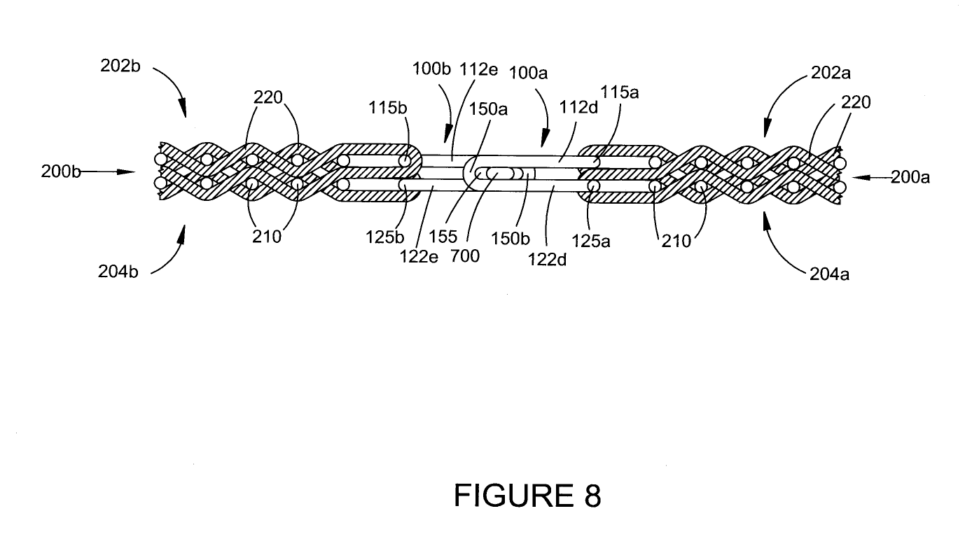

Referring now to FIGS. 7 and 8, these show a fabric of the invention in which a pair of seaming elements 100a, 100b has been secured to respective folded fabric regions 230a and 230b of fabric ends 200a, 200b, in the manner shown in FIGS. 5 and 6, between the respectively upper and lower layers, i.e. 202a, 204a for fabric end 200a, and 202b, 204b for fabric end 200b, so that the outer free ends 115a, 125a, and 115b, 125b engage with the folded yarns 220. After being thus secured to the fabric, the respective connecting portions 150a, 150b and adjacent leg portions of the segments, shown in FIG. 8 as exemplary segments 112d, 122d, 112e, 122e of each of seaming elements 100a, 100b extend through the apertures between the folded yarns 220. The protruding portions of the first seaming element 100a are interdigitated between the protruding portions of the second seaming element 100b, and connected together and secured by a pintle 700.

In this embodiment, to provide the seam for the woven fabric 200, the two seam areas are prepared by establishing the appropriate location in the textile for two fold lines which will subsequently become the edges of the textile. At those fold line locations, at least one CD yarn element can be removed from the textile at or proximate to each fold line so as to form a line of apertures across the CD in the array of yarn elements of the textile, between exposed MD yarn elements at those locations. In certain textile structures, it may be possible to push or crowd one or several of the CD yarn elements at the fold line sufficiently to form apertures of adequate size to accommodate the connecting portions 150 and allow them to protrude through the apertures. A seaming element 100 can then be inserted into and partly through the apertures, as shown in FIGS. 4 to 6. At this stage, a temporary securing element, such as a pintle (not shown) can be inserted through the channels 155 of each of the pair of seaming elements 100. When it is desired to close the seam for use of the textile in its intended operating environment, the temporary elements can be removed from the channels 155 and the two textile ends brought together, as shown in FIGS. 7 and 8, so that the connecting portions 150 of the two seaming elements 100a, 100b can be interdigitated and secured together by the insertion of a securing means such as pintle 700.

As a further option in addition to or substitution for the use of temporary securing elements, the seaming elements 100a, 100b, once in position with the looping portions through the apertures, can be further secured in that position by various means, including the insertion of stuffer yarns (not shown), into the folded fabric regions 230a, 230b between the outer free ends 115a, 125a, 115b, 125b of the seaming elements 100a and 100b, and a cross-machine direction yarn 210 of the fabric 200; or by stitching of the textile.

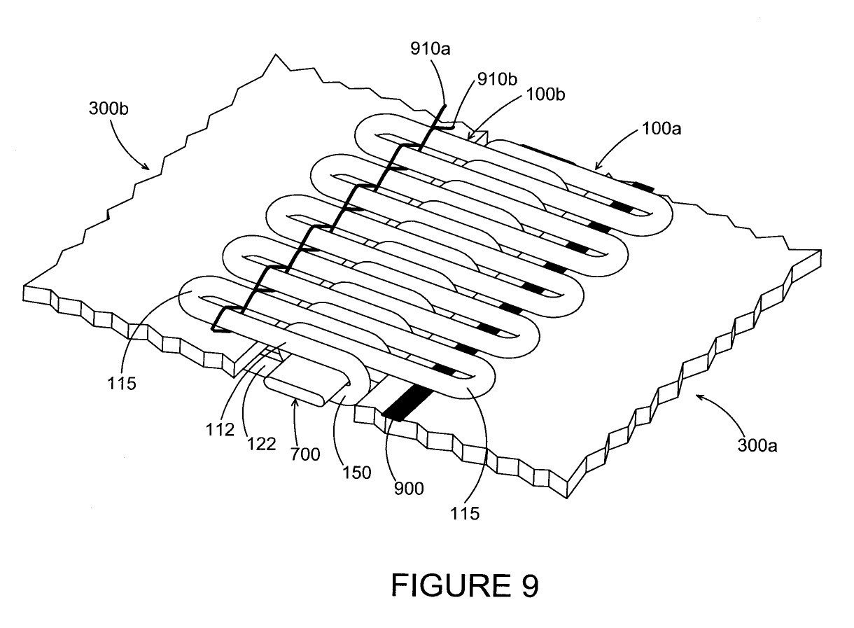

FIG. 9 is a perspective view of the seam area of opposing fabric ends 300a, 300b of an industrial textile. In this embodiment, a pair of filamentary seaming elements 100a and 100b have been bonded to the exterior surfaces of the opposing fabric ends 300a, 300b. The fabric may be any one of a fully woven structure, a multiaxial fabric structure, an array of parallel yarns, or a film construction. As shown in FIG. 9, each of the pair of seaming elements 100a and 100b comprises a continuous filamentary structure as shown in FIG. 1. The seaming elements 100a, 100b are secured to the respective fabric ends 300a, 300b, such that the upper layer of looped segments 112 of each seaming element is above the respective one of the fabric ends, and the lower layer of looped segments 122 of each seaming element is beneath the respective one of the fabric ends. Once secured in this position to the fabric ends 300a, 300b, the seaming elements 100a, 100b are brought together to form channel 155 between the interdigitated connecting portions 150 (in the same manner as described above in relation to FIGS. 7 and 8) and joined by a means of a pintle 700. Similarly, the respective outer free ends 115 and 125 (not shown) are on the exterior surfaces of the fabric and are bonded in place to those surfaces by an appropriate bonding means. For example, a material sensitive to radiation, such as laser energy absorbing strip 900 shown in FIG. 9, can be provided to selected ones of the inner surfaces 132, 133 (shown in FIG. 6) of either or both of the looped segments 112, 122, and/or to the surfaces of the fabric ends 300a, 300b.

Alternatively, where the seaming elements 100a, 100b are constructed of a thermoplastic polymer material, a laser energy absorbing material, such as carbon black or a radiant energy absorbing dye, can be incorporated by uniform dispersal within the polymer material, or within the polymer material of an outer layer in a co-extrusion process. Alternatively, a coating or thin film of a laser energy absorbing primer material, such as ClearWeld™, available from Gentex Corp. of Carbondale, Pa., USA, can be applied to the fabric surfaces where the desired bond is to be formed, such primer material being applied in the form of a liquid or thin film.

To stabilize the looped segments of the seaming elements 100a, 100b until they are secured to the fabric ends 200a, 200b, one or more pairs of yarns can be interwoven in an interlocking manner across the looped segments 112, 122, such as 910a, 910b shown in FIG. 9 in relation to seaming element 100b. As a further option, either or both of yarns 910a, 910b can comprise a laser energy absorbing material, to facilitate the bonding of the seaming element 100b in the same manner as strip 900 for seaming element 100a.

The seaming element 100 of the invention has a caliper, i.e. measured from the plane of the outer surfaces of each of the segments 112 through the element to the plane of the outer surfaces of each of the segments 122, approximately equal to that of the fabric into which it is to be installed so as to minimize any possible discontinuity in fabric caliper arising from its installation. The seaming element is formed from a metal wire or a single thermoplastic yarn, such as a polymeric monofilament, or other yarn types noted above, which has been permanently deformed, for example by wrapping it about an appropriate jig so as to obtain the desired shape, and then subjecting the deformed yarn to heat and pressure so as to permanently plastically deform it to the desired shape configuration, having regard to the yarn or MD component density of the base fabric into which it is to be installed, and the size of the yarns or MD components in the base fabric.

The sizing of the seaming element 100 can be selected to meet the requirements of the intended end use, whether the fabric is woven or nonwoven, and in the latter case, whether it is formed from yarns, strips or layers of a film, or a fibrous material. The filamentary yarn size used in the seaming element can be selected in accordance with need, and taking into account the physical properties of the fabric. For installation into a fabric comprising yarns, relevant properties will include the yarn size and mesh of the fabric, but in general the filamentary yarn size can be less than, equal to, or greater than the size of the yarns used in the fabric.

In embodiments where the seaming element is to be installed within a fold in the fabric, the maximum yarn size that can be used to form a seaming element that will fit in the fabric fold area and allow the seaming element to be joined without deformation will be less than the maximum yarn size the fabric fold area can dimensionally accommodate without distortion. Generally, the size of the yarn which may be used in a seaming element, which will allow it to be joined to another similar element while maintaining without distortion the shape of both elements, will be about 25% less than the size of seaming element yarn that a fabric can actually accommodate.

The yarn used in the seaming element can be formed from any suitable material, including polyesters, such as PET, PBT, PEN and the like, polyamides, such as any of the nylons commonly used in industrial textiles including nylon-6, nylon-66, nylon-6/10, and the like, as well as other polymers commonly used in the manufacture of such textiles. The seaming element may also be made from a metal wire, such as stainless steel or other suitable metals. The yarns used to form the seaming element must be capable of permanent deformation into the required shape, and must have sufficient strength to prevent their fracture when subjected to the tensile forces to which the fabric is exposed while in use. The yarns are preferably comprised of a single monofilament; however, other materials and configurations may be used, including, but not limited to, cabled monofilaments, or sheath-core yarns in which the core is formed from a single monofilament or several monofilaments cabled together, and the sheath is comprised of a material having a lower melt point than the core, which yarn is capable of permanent thermoplastic deformation under heat and pressure.

While the seaming element of this invention has been described for use in woven fabrics, or fabrics provided with one or more MD yarn systems, it is not so limited, and may be employed in fabrics comprised entirely of a nonwoven material, such as a film, a plurality of film strips such as a slit film, or other fibrous structures such as are known. All that is required for the seaming element to be effective in such fabrics is the provision of adequate anchorage for the free ends of the element in the fabric. The seaming element may thus find use in a variety of textiles, and may be used to join fabric components in both the MD (i.e. as a cross-machine direction oriented seaming element) or the CD (as a machine direction oriented seaming element). In the latter orientation, the seaming element may be useful for attaching MD oriented fabric strips together in the longitudinal direction, or for attaching reinforcing or other materials to the outer edges of a woven or nonwoven fabric.

1. A seaming element for seaming edges of an industrial textile, the seaming element comprising a continuous filamentary structure deformedly set in an elongated configuration, the continuous filamentary structure comprising a plurality of looped segments alternated with connecting portions, wherein
(i) each connecting portion is spaced apart from each adjacent connecting portion and is configured to separate adjacent ones of the looped segments alternately into a first layer of looped segments and a second layer of looped segments;
(ii) each looped segment comprises a looped outer free end portion and two leg portions, each leg portion extending in the respective one of the first layer and the second layer from the outer free end portion to an adjacent one of the connecting portions;
(iii) the looped segments of the first layer are coplanar in a first plane and are aligned with each other at their respective outer free end portions, and the looped segments of the second layer are coplanar in a second plane substantially parallel to the first plane and are aligned with each other at their respective outer free end portions;
(iv) each connecting portion extends in a direction substantially perpendicular to the respective adjacent leg portions; and
(v) the outer free end portions of the seaming element are constructed and arranged to be securable directly to a selected first edge of the industrial textile, such that the connecting portions of the seaming element are engageable in securable alignment with the corresponding connecting portions of a complementary seaming element correspondingly provided at an opposing second edge of the industrial textile, the connecting portions together defining a continuous longitudinal channel.

2. (canceled)

3. A seaming element according to claim 1 or claim 2, wherein the industrial textile comprises a textile body, the first edge comprising a first folded end region having a first fold line, the second edge comprising a second folded end region having a second fold line, wherein portions of the industrial textile adjacent to the first and second fold lines respectively define first and second internal spaces, and each of the first and second fold lines comprises a plurality of spaced apart apertures, and the seaming element is constructed and arranged to be insertable into and securable within the first internal space, such that
(a) the connecting portions and at least part of the leg portions of each of the first looped segments and each of the second looped segments protrude through the apertures along the first fold line;
(b) the textile body between the apertures along the first fold line engages securably with the aligned outer free ends of the first and second looped segments.

4. (canceled)

5. A seaming element according to claim 1, wherein at least some of the looped segments further comprise at least one securing means constructed and arranged to secure the seaming element to a selected one of the edges of the industrial textile, the securing means comprising a material sensitive to radiation selected from UV radiation, laser radiation, visible and infrared light, microwave radiation, ultrasound and heat and provided to at least some of the looped segments of at least one of the first and second layers.

6. A seaming element according to claim 5, wherein the looped segments of the first and second layers comprise outer surfaces and opposing inner surfaces, and the seaming element is securable to the industrial textile along surfaces selected from at least some of the outer surfaces and at least some of the inner surfaces of at least one of the first and second layers.

7. (canceled)

8. (canceled)

9. A seaming element according to claim 6, wherein the continuous filamentary structure is constructed of a thermoplastic polymer material selected from a polyester and a polyamide and including a substantially uniformly dispersed laser energy absorbing material.

10.-12. (canceled)

13. A seaming element according to claim 6, wherein the continuous filamentary structure is constructed of a material selected from an extruded polymer and metal wire, and the material sensitive to radiation is a laser energy absorbing material selected from carbon black and a radiant energy absorbing dye and is selected from a coating layer and a film layer.

14.-17. (canceled)

18. A seaming element according to claim 6, wherein the seaming element further includes an external securing means secured to at least some of the looped segments of at least one of the first and second layers at surfaces selected from the their inner surfaces and the outer surfaces.

19. (canceled)

20. A seaming element according to claim 18, wherein the external securing means comprises at least one bondable strip comprising a thermoplastic polymer material and secured to the looped segments of at least one of the first layer and the second layer.

21. (canceled)

22. (canceled)

23. A seaming element according to claim 18, wherein the external securing means comprises at least one pair of bondable yarns interlockingly interwoven with each other and with selected ones of the looped segments of at least one of the first layer and the second layer.

24. (canceled)

25. A seaming element according to claim 3, wherein the industrial textile comprises yarns, and the textile body between the apertures along each fold line comprises selected folded ones of the yarns.

26. (canceled)

27. An industrial textile comprising a pair of seaming elements according to claim 1.

28. An industrial textile according to claim 27, wherein the seaming elements are bonded to the industrial textile by a bonding means selected from at least one of an adhesive bond, an epoxy bond, a chemically reactive bond, an ultrasonic weld, a laser weld and a stitched bond.

29.-40. (canceled)

41. A method of preparing a seam area for an industrial textile, the industrial textile comprising first and second seamable edges, the method comprising
(a) providing a first seaming element and a complementary second seaming element, each according to claim 1;
(b) selectively providing securing means to selected ones of the first seaming element, the second seaming element, and the industrial textile adjacent the first and second seamable edges; and
(c) securing the first seaming element directly to the first seamable edge and securing the second seaming element directly to the second seamable edge.

42. A method according to claim 41, wherein the providing in step (a) comprises constructing at least one of the first seaming element and the second seaming element of a thermoplastic polymer material selected from a polyester and a polyamide and including a material sensitive to radiation selected from UV radiation, laser radiation, visible and infrared light, microwave radiation, ultrasound and heat.

43. (canceled)

44. A method according to claim 42, wherein the selectively providing in step (b) comprises providing a securing means secured to at least some of the looped segments of at least one of the first and second layers at surfaces selected from inner surfaces and outer surfaces of the looped segments.

45. (canceled)

46. A method according to claim 41, wherein the selectively providing in step (b) comprises providing securing means selected from at least one bondable strip comprising a thermoplastic polymer material, and at least one pair of bondable yarns interlockingly interwoven with each other and with selected ones of the looped segments of a layer selected from the first layer and the second layer of at least one of the first seaming element and the second seaming element.

47.-49. (canceled)

50. A method according to claim 41, of preparing a seam area for an industrial textile, the method comprising before step (a) the step of
(a.0) providing a first folded end region having a first fold line to comprise a first seaming location and a second folded end region having a second fold line to comprise a second seaming location, the first and second fold lines defining first and second internal spaces between textile body portions adjacent to the first and second fold lines respectively, and providing along each of the first and second fold lines a plurality of spaced apart apertures between the textile body portions; and
wherein step (c) comprises
(c.1) inserting the first seaming element within the first internal space, and inserting the connecting portions and at least part of the leg portions of each of the first looped segments and each of the second looped segments through the apertures to form a plurality of first protrusions from the first fold line such that outer free ends of each of the first and second looped segments are engaged with the textile body portions along the first fold line;
(c.2) inserting the second seaming element within the second internal space, and inserting the connecting portions and at least part of the leg portions of each of the first looped segments and each of the second looped segments through the apertures to form a plurality of second protrusions from the second fold line such that the outer free ends of each of the first and second looped segments is engaged with the textile body portions along the second fold line; and
(c.3) securing each of the first and second elements within the respective first and second internal spaces.

51. A method according to claim 50, wherein the industrial textile comprises yarns, and step (b) comprises removal of selected yarns substantially parallel to and at the fold line.

52. (canceled)

53. A method according to claim 50, wherein the securing in step (c.3) comprises securing each seaming element to retain the looped segments in a protruding position by means selected from stitching, and inserting a retaining element adjacent the location of engagement of the outer free ends of each seam element with the fabric body portions, wherein the retaining element is selected from a pin, a pintle, and a filling yarn element, the filling yarn element being selectively provided with an adhesive coating, and selected from a monofilament yarn, a cabled monofilament yarn, a multifilament yarn, a spun yarn and a braided material.

54.-59. (canceled)

60. A method according to claim 50, wherein the securing in step (c.3) comprises inserting a melt-fusible retaining yarn element selected from a monofilament yarn, a cabled monofilament yarn, a multifilament yarn, a spun yarn and a braided material and being sensitive to radiation selected from UV radiation, laser radiation, visible and infrared light, microwave radiation, ultrasound and heat.

61.-66. (canceled)
